(19) United States
(12) Patent Application Publication
(10) Pub. No.: US 2025/0310870 A1
(43) Pub. Date: Oct. 2, 2025

(54) TERMINAL DEVICE REGISTRATION SWITCHING METHOD

(71) Applicant: Yealink (XIAMEN) Network Technology Co., Ltd., Xiamen (CN)

(72) Inventor: Haiming WENG, Xiamen (CN)

(73) Assignee: Yealink (XIAMEN) Network Technology Co., Ltd., Xiamen (CN)

(21) Appl. No.: 19/094,148

(22) Filed: Mar. 28, 2025

(30) Foreign Application Priority Data
Mar. 28, 2024 (CN) 202410366018.7

(51) Int. Cl. H04W 48/18; H04W 60/00; H04W 60/04; H04W 88/06

(52) U.S. Cl. CPC H04W 48/18; H04W 60/005; H04W 60/04; H04W 88/06

(57) ABSTRACT

A terminal device registration switching method is provided. The terminal device registration switching method includes: determining whether the terminal device meets a switching condition of a first network; and in response to determining that the terminal device meets the switching condition of the first network, sending a request for registering the terminal device with a second network.

### CROSS-REFERENCE TO RELATED APPLICATION

This application claims priority to and the benefit of Chinese Patent Application No. 202410366018.7, filed on Mar. 28, 2024, the disclosure of which is incorporated herein by reference in its entirety.

### TECHNICAL FIELD

The present disclosure relates to communications technologies, and in particular, to a terminal device registration switching method.

### BACKGROUND

Generally, when Internet Protocol (IP) Multimedia Subsystem (IMS) terminals are in a remote area with few base stations and weak signals, the stability of IMS terminal registration services cannot be ensured, which may affect daily communication of users.

### SUMMARY

In view of this, a terminal device registration switching method according to some embodiments of the present disclosure includes: determining whether the terminal device meets a switching condition of the first network; and in response to determining that the terminal device meets the switching condition of the first network, sending a request for registering the terminal device with a second network.

A terminal device according to some embodiments of the present disclosure includes a processor and a memory storing instructions executable by the processor to perform the above terminal device registration switching method.

Some embodiments of the present disclosure further provide a non-transitory computer-readable storage medium having stored thereon instructions executable by a processor to perform the above terminal device registration switching method.

### BRIEF DESCRIPTION OF THE DRAWINGS

FIG. 1 is a flowchart of a terminal device registration switching method according to some embodiments of the present disclosure.

FIG. 2 schematically shows a process of switching from a Long Term Evolution (LTE) network to a Voice over WiFi (VoWiFi) network according to some embodiments of the present disclosure.

FIG. 3 schematic a process of switching from a VoWiFi network to an LTE network according to some embodiments of the present disclosure.

FIG. 4 is a schematic block diagram of a terminal device registration switching apparatus according to some embodiments of the present disclosure.

FIG. 5 is a schematic block diagram of a terminal device according to some embodiments of the present disclosure.

### DETAILED DESCRIPTION

Some embodiments of the present disclosure will be described in detail below with reference to the accompanying drawings. The embodiments are described for illustrative purposes only and are not intended to limit the present disclosure.

Generally, when the IMS terminals are in a remote area with few base stations and weak signals, the stability of IMS terminal registration services cannot be ensured, which may affect daily communication of users.

Some embodiments of the present disclosure provide a terminal device registration switching method, a terminal device, and a storage medium. Specifically, an IMS terminal device registration switching method is provided. Registration stability of the IMS terminal device can be improved, which facilitates the improvement of the stability of IMS services (where the services are based on IMS registration) such as short messages, calls, and subscriptions.

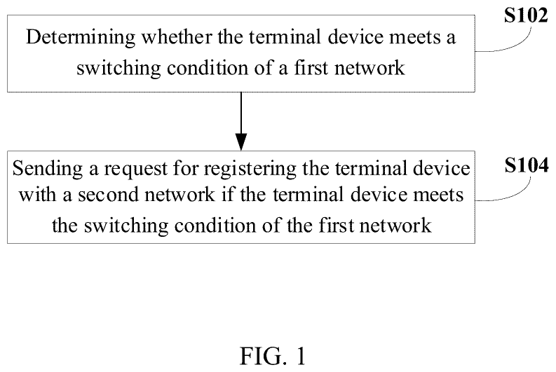

An embodiment of the present disclosure provides a terminal device registration switching method. Referring to the flowchart of a terminal device registration switching method shown in FIG. 1, the terminal device registration switching method includes following steps S102 and S104.

At step S102, whether the terminal device meets a switching condition of the first network is determined.

The terminal device in the embodiment may be an IMS terminal device, and the IMS terminal device may first be successfully registered with the first network. In the embodiment, it may be determined once at a certain interval whether the terminal device meets the switching condition of the first network. The first network in the embodiment may be different networks, and switching conditions of the different networks may be the same or different, which is not limited in the embodiment.

At step S104, if the terminal device meets the switching condition of the first network, the terminal device sends a request for registering the terminal device with a second network.

If the terminal device meets the switching condition of the first network, it is indicated in this case that the terminal device needs to perform network switching, and the terminal device may send a request for registering the terminal device with a second network different from the first network. If the terminal device does not meet the switching condition of the first network, it is indicated in this case that the terminal device does not need to perform network switching, and the terminal device may keep registration with the first network.

The embodiment of the present disclosure provides the terminal device registration switching method, where, whether the terminal device meets a switching condition of a first network is determined; and the terminal device sends a request for registering the terminal device with a second network if the terminal device meets the switching condition of the first network. As such, the registration stability of the IMS terminal device can be improved, which facilitates the improvement of the stability of IMS services such as short messages, calls, and subscriptions.

The embodiment provides another terminal device registration switching method, which is implemented on the basis of the above-discussed embodiments. In some embodiments, the first network is an LTE network, and the second network is a non-LTE network, where the non-LTE network includes any one of various well known networks except the LTE network, such as a VoWiFi (i.e., a IP voice service based on WiFi network) network, a Bluetooth network, a Zigbee network, or the like; or the first network is a VoWiFi network, and the second network is a non-VoWiFi network, where the non-VoWiFi network includes any one of various well known networks except the VoWiFi network, such as, the LTE network, a 5G network, or the like. LTE is a mobile communication technology and one of the fourth generation (4G) wireless communication standards.

If the first network is the LTE network and the second network is the VoWiFi network, the switching from the LTE network to the VoWiFi network may be implemented in the embodiment. If the first network is the VoWiFi network and the second network is the LTE network, the switching from the VoWiFi network to the LTE network may be implemented in the embodiment.

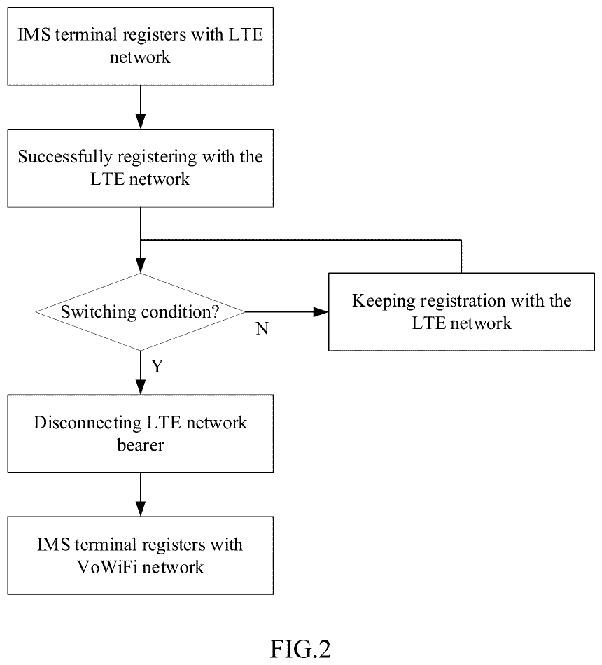

A schematic diagram of a switching from the LTE network to the VoWiFi network shown in FIG. 2 may be referred to. The IMS terminal device initiates registration to establish an LTE IMS Access Point Name (APN) network bearer and enable the registration to be successful.

The APN is a parameter for a mobile network, and allows a mobile device to be connected to a data network of an operator. Each operator has its own APN settings for configuring a device to access a mobile data network specific to the operator. The IMS APN configuration allows the mobile device to be connected to the operator's IMS network so as to use IMS services.

As shown in FIG. 2, when a switching condition is met, a switching may be actively performed to the VoWiFi network for registration. When the switching condition is not met, the registration with the LTE network may be kept.

In some embodiments, if the first network is the LTE network, the switching condition of the first network includes: a 4G signal of the terminal device has a strength less than a preset first threshold, the terminal device being in a 2G network, or the terminal device being in a 3G network.

Whether the registration switching meets the threshold may be illustrated by using the following configuration.

Configuration 1: controlling the switching to be performed if a signal is lower than N bars (which can be configured and/or controlled) for a continuously specified duration. For example, when the terminal device is in the LET registration, if a signal is lower than 3 bars (which is a normal range in the industry) for five minutes, then the switching is performed. If a signal having 5 bars appears in the continuously specified duration, a timer is reset.

Configuration 2: controlling one switching to be not performed for a continuously specified duration after another switching so as to prevent oscillation. For example, when the terminal device is in the LET registration, if the threshold is met, a switching from the LET registration to the VoWiFi registration is performed. In this case, another switching from the VoWiFi registration to the LTE registration cannot be performed for N seconds.

That is, if the first network is the LTE network, the switching condition of the first network includes: a 4G signal or a 5G signal of the terminal device being lower, or the terminal device being in a 2G network or a 3G network.

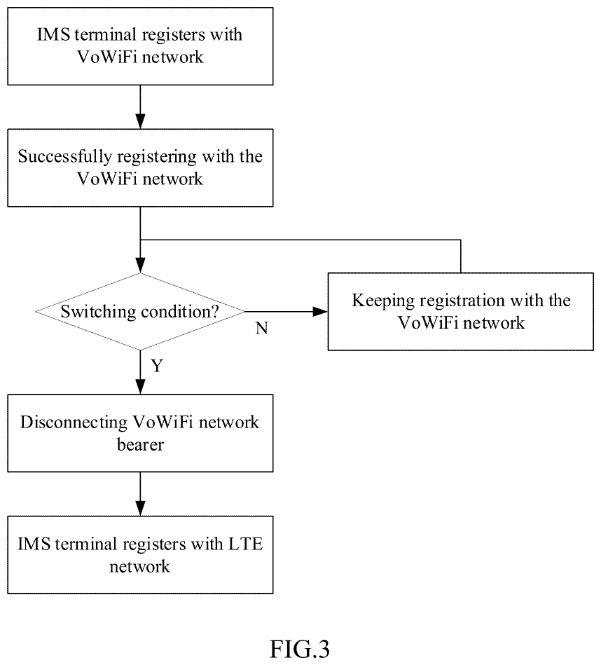

A schematic diagram of a switching from the VoWiFi network to the LTE network shown in FIG. 3 may further be referred to. The IMS terminal device initiates registration to establish an Evolved Packet Data Gateway (EPDG) network bearer and enable the registration to be successful.

A main function of the EPDG channel is to transmit VoWiFi voice data from the mobile device to the IMS network, and transmit the voice data from the IMS network back to the mobile device. The EPDG channel is connected to the mobile device via a WIFI network and communicates with other elements in the IMS core network, such as a Serving Call Session Control Function (S-CSCF) and a Proxy Call Session Control Function (P-CSCF).

As shown in FIG. 2, when the switching condition is met, a switching may be actively performed to the LTE network for registration. When the switching condition is not met, the registration with the VoWiFi network may be kept.

In some embodiments, if the first network is the VoWiFi network, the switching condition of the first network includes: a WIFI signal of the terminal device having a strength less than a preset second threshold (for example, a received signal strength indicator RSSI<−90 dbm), or a LTE network signal of the terminal device being greater than a preset third threshold (for example, an LTE reference signal received power RSRP>−100 dbm or LTE reference signal received quality RSRQ<−20 dbm), where RSRP and RSRQ may be separately controlled by configuration).

That is, if the first network is the VoWiFi network, the switching condition of the first network includes: the WIFI signal of the terminal device being lower, or the signal of the LTE network of the terminal device is higher.

In some embodiments, before the terminal device sends the request, the method further includes: disconnecting, by the terminal device, registration with the first network, or keeping, by the terminal device, registration with the first network.

That is, in the embodiment, before sending the request, the terminal device may keep registration with the first network, or may disconnect registration with the first network.

As shown in FIG. 2, when the IMS terminal device is registered with the VoWiFi network, the terminal device supports disconnecting the LTE IMS APN network bearer to ensure that there is no conflict between the LTE network and the VoWiFi network of the operators. Then, it is determined that the registration of the IMS terminal device with the VoWiFi network is successful

As shown in FIG. 3, when the IMS terminal device is registered with the LTE network, the terminal supports disconnecting the VoWiFi EPDG network bearer to ensure that there is no conflict between the LTE network and the VoWiFi network of the operators. Then, it is determined that the registration of the IMS terminal device to the LTE network is successful.

In some embodiments, the terminal device sends a request for registering the terminal device with the second network if a number of times the terminal device consecutively fails to be registered with the first network is greater than a preset number threshold; or the terminal device sends a request for registering the terminal device with the first network if a number of times the terminal device consecutively fails to be registered with the second network is greater than the preset number threshold.

In the embodiment, if a number of times the terminal device consecutively fails to be registered with one of the first network and the second network is excessive, a switching may be actively performed to another network of the first network and the second network for registration. For example, when the registration of the IMS terminal device in the VoWiFi network fails or the registration renewal fails, a switching may be actively performed to the LTE network for registration. When the registration of the IMS terminal device in the LTE network fails or the registration renewal fails, a switching may be actively performed to the VoWiFi network for registration.

That is, the method provided in the embodiment supports the switching after N number of times (that is, a number of threshold is N, and N may be set to 3 according to the standard of the 3rd Generation Partnership Project 3GPP), where the N may be controlled by user configuration. For example, the number of threshold of N may be set to be less than 10. Alternatively, the number of threshold of N may be set to be 3, 4 or 5.

In some embodiments, after the terminal device is successfully registered with the first network, the terminal device does not send a request for registering the terminal device with the second network within a preset period of time; and after the terminal device is successfully registered with the second network, the terminal device does not send a request for registering the terminal device with the first network within the preset period of time. For example, the preset period of time may be dynamically adjusted by using Binary Exponential Backoff Algorithm (BEBA), where the BEBA is a classical algorithm used in solving data transmission conflicts.

In the embodiment, after the terminal device is successfully registered with one of the first network and the second network, a switching may be not performed by the terminal device to another network of the first network and the second network for registration within a duration (for example, 5-15 minutes) after the terminal device is successfully registered with the one of the first network and the second network, so as to prevent oscillation of the network registration.

According to the foregoing method provided in the embodiments of the present disclosure, when a switching condition is met, registration with the LTE network and registration with the VoWiFi network may be switched, which may include following scenarios:
(1) When a LTE network signal is weak (that is, the signal is continuously weak for a duration) or the LTE network is in 2G or 3G, the IMS terminal device is switched from registration with the LTE network to registration with the VoWiFi network. A threshold of the signal of the LTE network may be configurable.
(2) When a WIFI signal quality is poor, the IMS terminal device is switched from registration with the VoWiFi network to registration with the LTE network. A threshold of the WIFI signal may be configurable.
(3) When the signal of the LTE network is strong, the IMS terminal device is switched from registration with the LTE network to registration with the VoWiFi network. The threshold of the signal of the LTE network may be configurable.

The foregoing method provided in the embodiments of the present disclosure supports preventing oscillation between registration with the LTE network and registration with the VoWiFi network, that is, no switching is performed again for a duration after a switching of registration succeeds. The specific duration may be configurable.

According to the foregoing method provided in the embodiments of the present disclosure, when a switching occurs between the LTE network and the VoWiFi network, the IMS terminal device supports active disconnection of another network bearer or maintenance of two network bearers.

For example, when a switching is performed from the LTE network to the VoWiFi network for registration, the IMS terminal supports disconnecting IMS APN network bearer of the LTE network; and when a switching is performed from the VoWiFi network to the LTE network for registration, the IMS terminal supports disconnecting EPDG network bearer of the VoWiFi network.

According to the foregoing method provided in the embodiments of the present disclosure, when the registration of the IMS terminal device in one of the LTE network and the VoWiFi network fails or the registration renewal fails (a number of failures may be controlled), a switching may be actively performed by the IMS terminal device to another network of the LTE network and the VoWiFi network for registration. The foregoing method according to the embodiments of the present disclosure can improve the registration stability of the IMS terminal, which not only facilitates the load balancing of the server and reduces the pressure load of the server, but also facilitates the improvement of the stability of IMS services such as short messages, calls, and subscriptions, and also facilitates the improvement of call quality. For example, when a LTE signal is weak but a WIFI signal is strong, the IMS registration switching helps ensure the call stability.

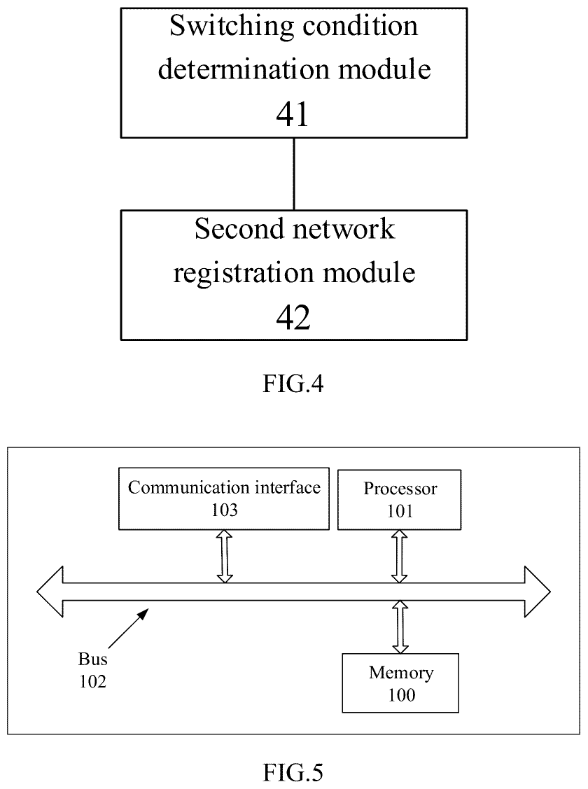

Corresponding to the embodiments of the foregoing methods, another embodiment of the present disclosure provides a terminal device registration switching apparatus. Referring to a schematic block diagram of a terminal device registration switching apparatus shown in FIG. 4, the terminal device registration switching apparatus includes:
a switching condition determination module 41 for determining whether the terminal device meets a switching condition of the first network; and
a second network registration module 42 for, in response to determining that the terminal device meets the switching condition of the first network, sending a request for registering the terminal device with a second network.

The embodiment of the present disclosure provides the terminal device registration switching apparatus, where, whether the terminal device meets a switching condition of a first network is determined; and the terminal device sends a request for registering the terminal device with a second network if the terminal device meets the switching condition of the first network. As such, the registration stability of the IMS terminal device can be improved, which not only facilitates the load balancing of the server and reduces the pressure load of the server, but also facilitates the improvement of the stability of IMS services such as short messages, calls, and subscriptions, and also facilitates the improvement of call quality. For example, when a LTE signal is weak but a WIFI signal is strong, the IMS registration switching helps ensure the call stability.

The first network is an LTE network, and the second network is a non-LTE network; or the first network is a Voice over WiFi (VoWiFi) network, and the second network is a non-VoWiFi network.

If the first network is the LTE network, the switching condition of the first network includes: a 4G signal or a 5G signal of the terminal device being less than a preset first threshold, the terminal device being in a 2G network, or the terminal device being in a 3G network.

If the first network is the VoWiFi network, the switching condition of the first network includes: a WIFI signal of the terminal device being less than a preset second threshold, or a LTE network signal of the terminal device being greater than a preset third threshold.

The apparatus further includes: a first network disconnection or keeping module for disconnecting, by the terminal device, registration with the first network, or keeping, by the terminal device, registration with the first network.

The apparatus further includes: a network registration failure module for, in response to determining that a number of times the terminal device consecutively fails to be registered with the first network is greater than a preset number threshold, sending a request for registering the terminal device with the second network; or in response to determining that a number of times the terminal device consecutively fails to be registered with the second network is greater than the preset number threshold, sending a request for registering the terminal device with the first network.

The apparatus further includes: a network registration success module for not sending the request for registering the terminal device with the second network within a preset period of time after the terminal device is successfully registered with the first network; and not sending a request for registering the terminal device with the first network within the preset period of time after the terminal device is successfully registered with the second network.

In another implementation of the present embodiment, the foregoing terminal device registration switching apparatus includes a processor and a memory stored with the modules described above including the switching condition determination module, the second network registration module, the first network disconnection or keeping module, the network registration failure module, and the network registration success module, where the processor is configured to execute the foregoing modules.

The embodiment of the present disclosure provides the terminal device registration switching apparatus, where, whether the terminal device meets a switching condition of a first network is determined; and the terminal device sends a request for registering the terminal device with a second network if the terminal device meets the switching condition of the first network. As such, the registration stability of the IMS terminal device can be improved, which not only facilitates the load balancing of the server and reduces the pressure load of the server, but also facilitates the improvement of the stability of IMS advanced services such as short messages, calls, and subscriptions, and also facilitates the improvement of call quality. For example, when a LTE signal is weak but a WIFI signal is strong, the IMS registration switching helps ensure the call stability.

It may be clearly understood by those skilled in the art that, for ease and brevity of description, a specific working process of the terminal device registration switching system described above may refer to a corresponding process in the foregoing embodiments of the terminal device registration switching method, which is not repeatedly described herein again.

Yet another embodiment of the present disclosure further provides a terminal device for running the above terminal device registration switching method. Referring to the schematic block diagram of a terminal device shown in FIG. 5, the terminal device includes a memory 100 and a processor 101, where the memory 100 is used to store one or more computer instructions, and the one or more computer instructions are executed by the processor 101 to implement the above terminal device registration switching method.

Furthermore, the terminal device shown in FIG. 5 further includes a bus 102 and a communication interface 103, where the processor 101, the communication interface 103, and the memory 100 are connected via the bus 102.

The memory 100 may include a high-speed Random Access Memory (RAM), or may further include a non-volatile memory, such as at least one disk memory. Communication connection between the system network element and at least one other network element is realized through at least one communication interface 103 (which may be wired or wireless), and the Internet, wide area network, local area network, metropolitan area network, etc. may be used. The bus 102 may be an ISA bus, a PCI bus, or an EISA bus, etc. The bus may be divided into an address bus, a data bus, a control bus, and the like. For ease of illustration, only one bi-directional arrow is shown in FIG. 5, but does not indicate that there is only one bus or one type of bus.

The processor 101 may be an integrated circuit chip having signal processing capabilities. In an implementation, the steps of the above method may be performed by integrated logic circuits of hardware in the processor 101 or by instructions in the form of a software. The processor 101 may be a general-purpose processor, including a Central Processing Unit (CPU), a Network Processor (NP), and the like; may also be a Digital Signal Processor (DSP), an Application Specific Integrated Circuit (ASIC), a Field-Programmable Gate Array (FPGA) or other programmable logic device, a discrete gate or transistor logic device, or a discrete hardware component. The methods, steps, and logical block diagrams disclosed in the embodiments of the present disclosure may be implemented or performed. The general purpose processor may be a microprocessor or the processor may be any conventional processor or the like. The steps associated with the method disclosed in the embodiments of the present disclosure may be embodied directly as being performed by a hardware decoding processor, or may be performed by a combination of a hardware and a software module in the decoding processor. The software module may be located in a storage medium matured in the art, such as a random access memory, a flash memory, a read only memory, a programmable read only memory, or an electrically erasable programmable memory, a register, or the like. The storage medium is located in the memory 100, and the processor 101 reads information stored in the memory 100 and performs the steps of the methods of the above embodiments in conjunction with its hardware.

The embodiment of the present disclosure provides the terminal device implementing the terminal device registration switching apparatus, where, whether the terminal device meets a switching condition of a first network is determined; and the terminal device sends a request for registering the terminal device with a second network if the terminal device meets the switching condition of the first network. As such, the registration stability of the IMS terminal device can be improved, which facilitates the improvement of the stability of IMS services such as short messages, calls, and subscriptions.

Yet another embodiment of the present disclosure further provides a non-transitory computer-readable storage medium stored with computer-executable instructions. When the computer-executable instructions are invoked and executed by a processor, the computer-executable instructions cause the processor to implement the above terminal device registration switching method. The specific implementation can refer to the method embodiments, which are not repeatedly described again herein.

Yet another embodiment of the present disclosure further provides a computer program product including a non-transitory computer-readable storage medium storing program codes, where instructions included in the program codes can be used to execute the method in the above method embodiments. The specific implementation can refer to the method embodiments, which are not repeatedly described again herein.

The embodiment of the present disclosure provides the computer program product implementing the terminal device registration switching method, where, whether the terminal device meets a switching condition of a first network is determined; and the terminal device sends a request for registering the terminal device with a second network if the terminal device meets the switching condition of the first network. As such, the registration stability of the IMS terminal device can be improved, which facilitates the improvement of the stability of IMS services such as short messages, calls, and subscriptions.

It will be apparent to those skilled in the art that, for the convenience and brevity of the description, a specific operation process of the system and/or apparatus described above may refer to corresponding process of the above-mentioned method embodiments and details thereof will not be repeatedly described herein.

Additionally, in the description of the embodiments of the present disclosure, the terms “installation”, “connection” and “coupling” should be understood in a broad sense, unless otherwise clearly specified and defined. For example, it can be a fixed connection, a detachable connection, or integrated connection; it can be a mechanical connection, or an electrical connection; it can be directly connected or indirectly connected through an intermediary, it can also be the connection between two elements. Those ordinary skilled in the art can understand the specific meanings of the above terms in the present disclosure according to specific situations.

If a function is achieved in the form of software functional units, and is sold or used as an independent product, it may be stored in a computer readable storage medium. Based on this understanding, the technical solution of the present disclosure or its portion, in essence or in part contributing to the prior art, may be embodied in the form of a software product stored in a storage medium diskette, optical disk) comprising instructions for causing a computer device (which may be a personal computer, a server, or a network device, etc.) to perform all or part of the steps described in the various method embodiments of the present disclosure. The above storage medium includes various media that can store program codes, such as, a U disk, a mobile hard disk, a Read-Only Memory (ROM), a Random Access Memory (RAM), a disk or optical disk, etc.

In the description of the present disclosure, it should be illustrated that orientations or position relationships indicated by the terms “center”, “upper”, “lower”, “left”, “right”, “vertical”, “horizontal”, “inside”, “outside” are based on orientations or position relationships illustrated in the drawings. The terms are used to facilitate and simplify the description of the present disclosure, rather than indicate or imply that the devices or elements referred to herein are required to have specific orientations or be constructed or operate in the specific orientations. Accordingly, the terms should not be construed as limiting the present disclosure. In addition, the term “first”, “second”, and “third” are for illustrative purposes only and are not to be construed as indicating or imposing a relative importance.

Some embodiments of the present disclosure have been described in detail above. The description of the above embodiments merely aims to help to understand the present disclosure. Many modifications or equivalent substitutions with respect to the embodiments may occur to those of ordinary skill in the art based on the present disclosure. Thus, these modifications or equivalent substitutions shall fall within the scope of the present disclosure as defined by the appended claims.

What is claimed is:

1. A terminal device registration switching method, comprising: by a terminal device, determining whether the terminal device meets a switching condition of the first network; and
in response to determining that the terminal device meets the switching condition of the first network, sending a request for registering the terminal device with a second network.

2. The method of claim 1, wherein the first network is a Long Term Evolution (LTE) network, and the second network is a non-LTE network; or
the first network is a Voice over WiFi (VoWiFi) network, and the second network is a non-VoWiFi network.

3. The method of claim 2, wherein the first network is the LTE network; and
the switching condition of the first network comprises: a 4G signal of the terminal device having a strength less than a preset first threshold, the terminal device being in a 2G network, or the terminal device being in a 3G network.

4. The method of claim 2, wherein the first network is the VoWiFi network; and
the switching condition of the first network comprises: a WIFI signal of the terminal device having a strength less than a preset second threshold, or an LTE network signal of the terminal device having a parameter greater than a preset third threshold.

5. The method of claim 1, further comprising: before sending the request,
disconnecting registration with the first network, or keeping registration with the first network.

6. The method of claim 1, further comprising:
in response to determining that a number of times the terminal device consecutively fails to be registered with the first network is greater than a preset number threshold, the terminal device sending a request for registering the terminal device with the second network; and
in response to determining that a number of times the terminal device consecutively fails to be registered with the second network is greater than the preset number threshold, the terminal device sending a request for registering the terminal device with the first network.

7. The method of claim 1, further comprising:
not sending the request for registering the terminal device with the second network within a preset period of time after the terminal device is successfully registered with the first network.
not sending a request for registering the terminal device with the first network within the preset period of time after the terminal device is successfully registered with the second network.

8. A terminal device, comprising:
a processor; and
a memory storing instructions executable by the processor to perform operations comprising:
determining whether the terminal device meets a switching condition of a first network; and
in response to determining that the terminal device meets the switching condition of the first network, sending a request for registering the terminal device with a second network.

9. The terminal device of claim 8, wherein the first network is an LTE network, and the second network is a non-LTE network; or
the first network is a Voice over WiFi (VoWiFi) network, and the second network is a non-VoWiFi network.

10. The terminal device of claim 9, wherein the first network is the LTE network; and
the switching condition of the first network comprises: a 4G signal of the terminal device having a strength less than a preset first threshold, the terminal device being in a 2G network, or the terminal device being in a 3G network.

11. The terminal device of claim 9, wherein the first network is the VoWiFi network; and
the switching condition of the first network comprises: a WIFI signal of the terminal device having a strength less than a preset second threshold, or an LTE network signal of the terminal device having a parameter greater than a preset third threshold.

12. The terminal device of claim 8, wherein the operations further comprise: before sending the request,
disconnecting registration with the first network, or keeping registration with the first network.

13. The terminal device of claim 8, wherein the operations further comprise:
in response to determining that a number of times the terminal device consecutively fails to be registered with the first network is greater than a preset number threshold, sending a request for registering the terminal device with the second network; and
in response to determining that a number of times the terminal device consecutively fails to be registered with the second network is greater than the preset number threshold, sending a request for registering the terminal device with the first network.

14. The terminal device of claim 8, wherein the operations further comprise:
not sending the request for registering the terminal device with the second network within a preset period of time after the terminal device is successfully registered with the first network; and
not sending a request for registering the terminal device with the first network within the preset period of time after the terminal device is successfully registered with the second network.

15. A non-transitory computer-readable storage medium having stored thereon instructions executable by a processor to perform operations comprising:
determining whether the terminal device meets a switching condition of the first network; and
in response to determining that the terminal device meets the switching condition of the first network, sending a request for registering the terminal device with a second network.

16. The storage medium of claim 15, wherein the first network is an LTE network, and the second network is a non-LTE network; or
the first network is a Voice over WiFi (VoWiFi) network, and the second network is a non-VoWiFi network.

17. The storage medium of claim 16, wherein the first network is the LTE network; and
the switching condition of the first network comprises: a 4G signal of the terminal device having a strength less than a preset first threshold, the terminal device being in a 2G network, or the terminal device being in a 3G network.

18. The storage medium of claim 16, wherein the first network is the VoWiFi network; and
the switching condition of the first network comprises: a WIFI signal of the terminal device having a strength less than a preset second threshold, or an LTE network signal of the terminal device having a parameter greater than a preset third threshold.

19. The storage medium of claim 15, wherein the operations further comprise: before sending the request,
disconnecting registration with the first network, or keeping registration with the first network.

20. The storage medium of claim 15, wherein the operations further comprise:
not sending the request for registering the terminal device with the second network within and
not sending a request for registering the terminal device with the first network within the preset period of time after the terminal device is successfully registered with the second network.
